(19) United States
(12) Patent Application Publication
(10) Pub. No.: US 2010/0274417 A1
(43) Pub. Date: Oct. 28, 2010

(54) System and Method of Interaction and Holistic Representation of Tasks

(75) Inventors: Jean-Noel Perbet, Eysines (FR); Benjamin Duban, Bordeaux (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/649,175

(22) Filed: Dec. 29, 2009

(30) Foreign Application Priority Data
Apr. 22, 2009 (FR) 09 01945

(51) Int. Cl. G06F 3/048; G06F 19/00

(52) U.S. Cl. 701/3; 715/772

(57) ABSTRACT

The general field of the invention is that of viewing systems comprising first means making it possible to process and to store the various data necessary for the accomplishment of a technical or industrial process, second means making it possible to determine the various tasks to be accomplished by a user in the course of the process on the basis of the previous data, a computer for generating graphical images associated with a viewing device and a man-machine interface with the said viewing device. The viewing device according to the invention displays a succession of graphical icons, each icon representing a task to be accomplished, the various icons being ordered according to a time scale extending from the start to the end of the process. The system and the method according to the invention are of global or holistic types. A certain number of operations on these icons can be performed by means of the man-machine interface. The favoured field of the invention is that of aircraft instrument panels.

### PRIORITY CLAIM

This application claims priority to French Patent Application Number 09 01945, entitled System and Method of Interaction and Holistic Representation of Tasks, filed on Apr. 22, 2009.

### FIELD OF THE INVENTION

The field of the invention is that of systems and associated methods of interaction and graphical representation of the tasks to be performed in the course of the conduct of a complex technical process stretching over time. It applies notably to the conduct of an aircraft flight or mission. The term “flight” is intended to mean not only the flight of the aircraft properly speaking but also the phases of flight preparation, taxiing, takeoff, flight and landing of the aircraft. The term “mission” is more suitable for designating a military aircraft flight having a particular aim (reconnaissance, surveillance, interception, destruction, etc.).

### DESCRIPTION OF THE PRIOR ART

By dint of the complexity of modern aircraft and the various procedures necessary for piloting and navigation, the management of a flight or of a mission of a modern aircraft requires a large number of tasks to be accomplished by the pilot or crew. To do their work, nowadays crews have at their disposal sophisticated man-machine interfaces composed essentially of viewing screens and control posts disposed on the instrument panel and interfaced with the Flight Management System (FMS). By dint of technological progress, it is possible for high-resolution screens of large size and electronic computers to be disposed on the instrument panel, thereby making it possible to display a large number of flight data and parameters. Thus, back in 1997, patent U.S. Pat. No. 6,112,141 from the company Dassault described in a precise manner an onboard system comprising an electronic computer, selection means and large display screens making it possible to display the various items of information necessary for piloting and navigation. Technology no longer being a strong constraint, it is therefore fundamental to determine the best way of graphically representing the data and the necessary information in such a way that the pilot can accomplish his work in the most intuitive possible manner and, of course, under the best possible safety conditions.

Among the conventional representations of the tasks to be accomplished, it is possible to group the information by flight phase. Thus, the pilot can have at his disposal on a screen all the information necessary to configure the cockpit before landing. Patent U.S. Pat. No. 6,707,475 from the company Honeywell entitled “System for selecting and displaying flight management system procedures” describes this type of representation. This scheme is notably implemented on the “Falcon” from the company Dassault. It is also possible to display “check-lists” or “To do lists” of the tasks to be accomplished. The latter technique is notably implemented on the aeroplanes of the Airbus and Boeing companies. Of course, the pilot also uses flight manuals which may be in paper form or in electronic form. All these systems exhibit certain drawbacks. The pilot or the crew do not have precise knowledge of the workload awaiting them. Thus, they are missing the “pace” of the mission. Moreover, the information on the tasks accomplished or not accomplished in the past is not provided to them. Thus, if in the course of the previous flight phase, a task was not performed completely, it is almost certain that this item of information will be lost. Finally, in the course of a flight phase, nothing indicates to them that certain tasks are prohibited.

The system and the method according to the invention do not exhibit these drawbacks. Unlike the current systems and methods which are of sequential type, the system and the method according to the invention are of global or holistic types.

### SUMMARY OF THE INVENTION

More precisely, the subject of the invention is a viewing system comprising at least first means making it possible to process and to store the various data necessary for the accomplishment of a technical or industrial process, second means making it possible to determine the various tasks to be accomplished by a user in the course of the process on the basis of the previous data, a computer for generating graphical images associated with a viewing device and a man-machine interface with the said viewing device, characterized in that the said viewing device displays a succession of graphical icons, each icon representing a task to be accomplished, the various icons being ordered according to a time scale extending from the start to the end of the process.

The invention applies most particularly to aircraft instrument panel viewing systems, the technical process being a flight or a mission of the said aircraft, the user being one of the members of the crew of the aircraft.

Advantageously, the viewing device displays a symbol representative of the aircraft, the position of the symbol on the time scale representing the aircraft at the present instant in such a way that the icons disposed before the symbol represent the past tasks and that the icons disposed after the symbol represent the future tasks.

Advantageously, the icons representing the tasks performed have a different representation from the icons representing the tasks yet to be performed; the icons representing the tasks not performed and which ought to have been have a different representation from the icons representing tasks performed or to be performed. Moreover, certain icons represent prohibited tasks. Finally, certain icons represent the tasks to be performed by a given operator.

Advantageously, when a determined time interval comprises a large number of tasks, the man-machine interface comprises means making it possible either to carry out a “zoom” of this time interval, or an expansion, or a reorganization. Moreover, a symbol linking at least two icons can be representative of the tempo at which the tasks represented by the said two icons are carried out. Finally, when a new future task of alarm type appears, a specific icon is displayed.

Advantageously, the man-machine interface comprises means making it possible to reveal for an icon representing a given task, either other icons representing associated tasks, or graphical windows, or menus.

Advantageously, the time scale is horizontal and the viewing device also displays, under the line of the graphical icons, either a vertical cross-sectional view of the terrain overflown in the course of the flight or mission, or a vertical cross-sectional view of the flight plan.

Preferably, the icons have the form of circles of different size. They can also have the form of polygons or a set the geometric shapes, circles and polygons.

Advantageously, the time scale is centred on the present instant and is limited to a shorter duration than that of the complete process.

### BRIEF DESCRIPTION OF THE DRAWINGS

The invention will be better understood and other advantages will become apparent on reading the description which follows given without limitation and by virtue of the appended figures among which:

FIG. 1 represents a view of the system according to the invention;

FIG. 2 represents a first exemplary display according to the invention;

FIGS. 3 to 7 represent detail views of a display according to the invention.

FIG. 8 represents a second exemplary display according to the invention.

### MORE DETAILED DESCRIPTION

For clarity reasons, the exemplary viewing system described below according to the invention relates to the aeronautical field and more precisely to that of aircraft instrument panels. Of course, the system according to the invention could apply to other technical fields such as the management of industrial manufacturing processes.

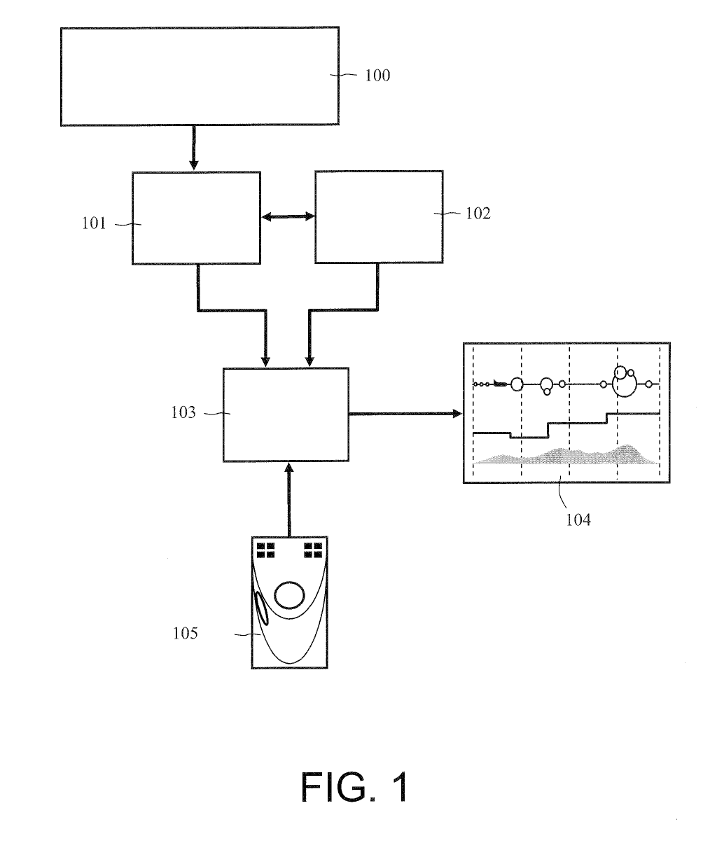

A viewing system according to the invention for aircraft is represented in FIG. 1. It comprises:
first means 101 making it possible to process and to store the context of the flight, that is to say the various specific data necessary for the accomplishment of a flight or of a mission of the aircraft. For example, in the case of a commercial flight, the departure and arrival airports, the flight plan and its various waypoints, the takeoff and landing times, etc. These first means are interfaced with the aeroplane system 100 as a whole;
second means 102 making it possible to determine the various tasks to be accomplished by the pilot in the course of the flight or mission on the basis of the previous data. This involves determining and adapting the general procedures such as takeoff or landing to the previous context, that is to say to particular airports;
an electronic computer 103 for generating graphical images whose input data emanate from the previous means;
a viewing device 104 or a set of viewing devices interfaced with the computer for generating graphical images. These viewing devices are disposed for example on the instrument panel or on an interactive screen positioned on the cockpit ceiling at the location of the overhead control panel. The display of the icons or of the graphical images representing the tasks to be accomplished can be carried out on a particular viewing device, dedicated to this task. It can also be carried out on several devices simultaneously, be reconfigurable, etc.;
a man-machine interface 105 with the said viewing device. This interface can be a device controlling a remote graphical pointer of computer “mouse” type. One then speaks of “CCD”, the acronym standing for “Cursor Control Device”. This interface can also be a control post, a tactile surface or any other means making it possible to interact directly or remotely with the display means. This designation will advantageously be able to use other commands of voice recognition type or of multimodal type by combining several means of dialogue and interaction. This holistic interface makes it possible to access all the icons, data and various commands displayed in full freedom, with no predetermined order.

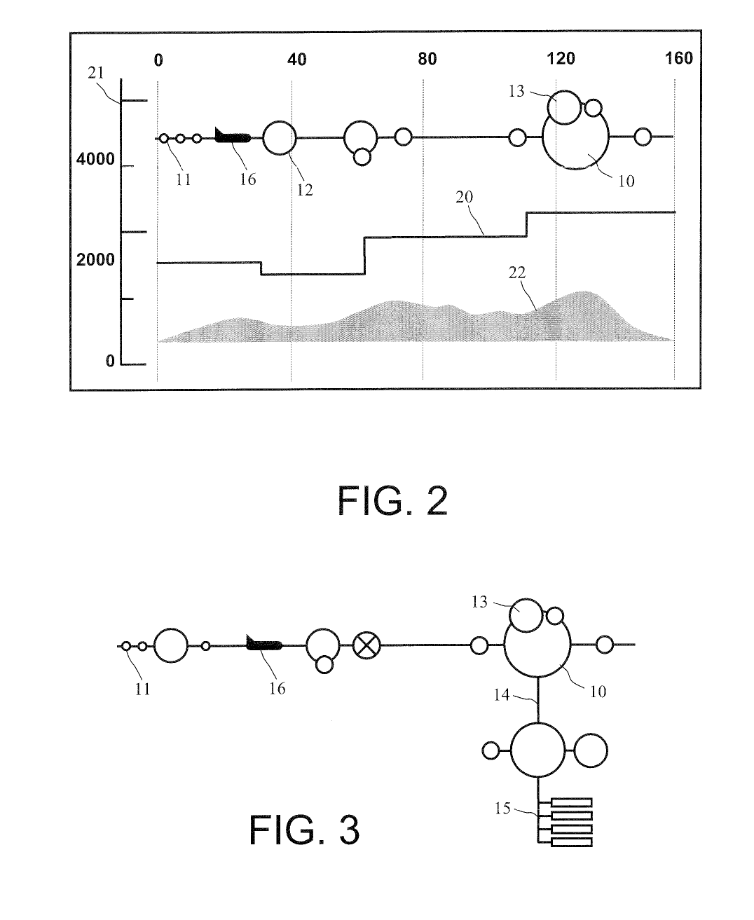

FIG. 2 represents a first exemplary display according to the invention. The graphical representation according to the invention essentially consists in displaying a succession of graphical icons 10, each icon representing a task to be accomplished, the various icons being ordered according to a time scale extending from the start to the end of the flight or mission. Thus, in FIG. 1, the time scale is graduated every 40 minutes, the total duration of the mission being 160 minutes. It is also possible to represent, in addition to the icons representing the tasks to be accomplished, information relating to the system of the craft, its resources, potential threats or dangers, messages, etc.

In this FIG. 2, the icons are represented by circles 10, 11, 12 and 13 of various sizes. It is possible to adopt other geometric shapes. It is also possible to mix the geometric shapes, circles and polygons, for example.

The representations of the circles can be representative either of the importance of the task, or of its accomplishment. Thus, the icons representing the tasks performed have a different representation from the icons representing the tasks yet to be performed, the icons representing the tasks not performed and which ought to have been, also have a different representation from the icons representing tasks performed or to be performed, finally certain icons represent prohibited tasks. In the same way, certain icons can represent tasks to be performed by a given operator. Finally, when a new future task of alarm type appears, a specific icon is displayed as indicated on the icon 17 of FIG. 7.

When a task is performed or when a task which ought to have been performed has not been performed in time, its change of representation is automatic, driven by the computer, without human interventions. It should be noted that the tasks performed can, to simplify the graphics, be totally deleted. The size of the circles can be used for these various representations. Thus, a task accomplished such as the task 11 of FIG. 2 is represented by a circle of very small diameter, signifying that it is already accomplished. It is of course also possible to use other modes of representation such as colour, contrast, semi-transparency, periodic change of appearance or flashing.

The icons can comprise a symbol representative of the task to be accomplished, preferably using the symbols conventionally used in aeronautics. Thus, the icon of FIG. 4 comprises a downwards-oriented broken arrow representing the craft's descent or approach phase. In the same way, a symbol representing a radiofrequency emitter will symbolize telecommunications.

Other secondary icons, representing for example the state of the resources available to accomplish the task, can also be grafted onto a main icon. Thus, the icon 13 is added to the icon 10. As indicated in FIG. 3, a main icon can also be supplemented with other branch-offs 14, lists of tasks 15 and more generally any type of windows such as they exist in the “Windows” environment defined by the “Microsoft” company.

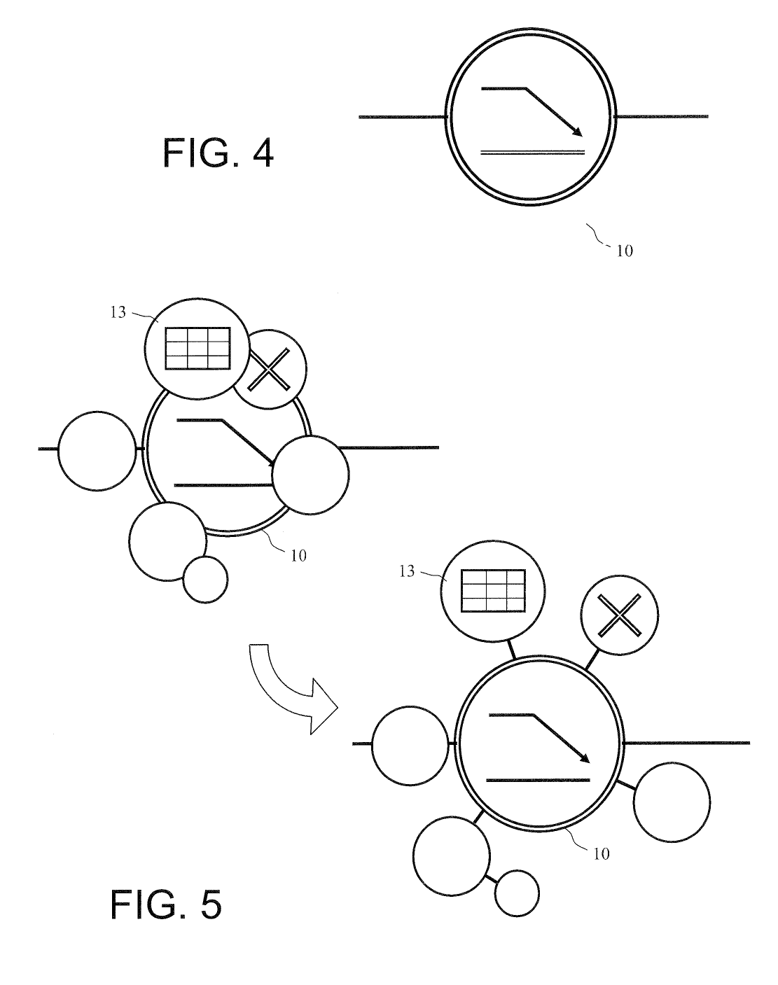

When the number of tasks to be accomplished in a given time span is very significant, the graphics then comprising a large number of icons in a restricted space, it is then possible, for clarity reasons, either to “zoom” in on this space, or to temporally expand it, or to “explode”, or carry out a “reorganization”. This operation is better known by the term “decluttering”. It consists in exploding the secondary tasks around a main task in such a way that they do not overlap, that they are linked to the main task and that they are clearly apparent. By way of example, this operation is represented in FIG. 5 which represents a grouping of icons before and after “decluttering”.

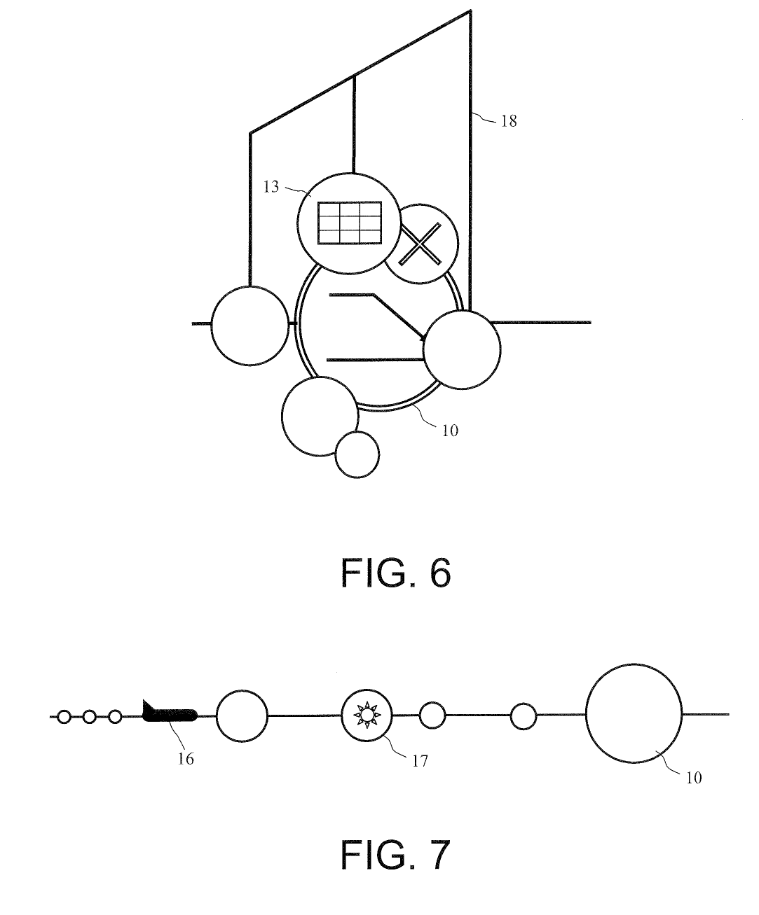

Another mode of representation consists in representing in an intuitive form all the tasks to be accomplished in a given time span by linking them together by a “tempo” symbol 18 as indicated in FIG. 6. In this figure, the tempo symbol consists of vertical branches linked together by an oblique branch. This symbol is very similar to that used in music theory.

The time scale can also comprise a symbol 16 representing the aircraft at the present instant. It is of course possible to represent the entire time scale. When the number of tasks is considerable, it may be more judicious to use a “sliding” window, the time scale being centred on the present instant and being limited to a shorter duration than that of the complete process.

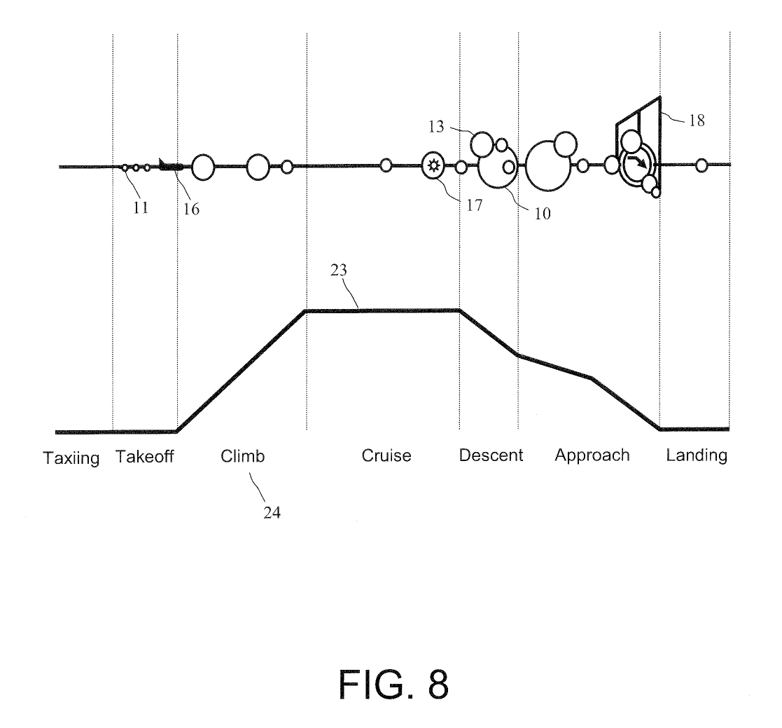

To complement the tasks scale, it is possible to add, as represented in FIG. 1, the various altitudes 20 of a flight plan as a function of a vertical altitude scale 21 or a cross-sectional view of the terrain 22, represented in grey in FIG. 1. It is also possible, as represented in FIG. 8, to add under the tasks scale, a flight plan 23, dependent on the altitude with its various phases 24 denoted “Taxiing”, “Takeoff”, “Climb”, “Cruise”, “Descent”, “Approach” and “Landing”. The icons 11, 13, 17 and 18 described previously appear again in this figure.

Thus, at any moment the pilot has at his disposal all the information relating to what he has done, what he has not done and what he has to do. Moreover, the tempo, the “pace” of what he will have to do, is indicated to him very clearly, making it possible to anticipate certain tasks.

What is claimed is:

1. Viewing system comprising at least first means making it possible to process and to store the various data necessary for the accomplishment of a technical or industrial process, second means making it possible to determine the various tasks to be accomplished by a user in the course of the process on the basis of the previous data, a computer for generating graphical images associated with a viewing device and a man-machine interface with the said viewing device, wherein the said viewing device displays a succession of graphical icons, each icon representing a task to be accomplished, the various icons being ordered according to a time scale extending from the start to the end of the process.

2. Viewing system according to claim 1, wherein the viewing system is an aircraft instrument panel system, the technical process a flight or a mission of the said aircraft, the user being one of the members of the crew of the aircraft.

3. Viewing system according to claim 2, wherein the viewing device displays a first symbol representative of the aircraft, the position of the symbol on the time scale representing the aircraft at the present instant in such a way that the icons disposed before the first symbol represent the past tasks and that the icons disposed after the first symbol represent the future tasks.

4. Viewing system according to claim 1, wherein the icons representing the tasks performed have a different representation from the icons representing the tasks yet to be performed.

5. Viewing system according to claim 1, wherein the icons representing the tasks not performed and which ought to have been, have a different representation from the icons representing tasks performed or to be performed.

6. Viewing system according to claim 1, wherein certain icons represent prohibited tasks.

7. Viewing system according to claim 1, wherein certain icons represent the tasks to be performed by a given operator.

8. Viewing system according to claim 1, wherein when a determined time interval comprises a large number of tasks, the man-machine interface comprises means making it possible either to carry out a “zoom” of this time interval, or an expansion, or a reorganization.

9. Viewing system according to claim 1, wherein a second symbol linking at least two icons is representative of the tempo at which the tasks represented by the said two icons are carried out.

10. Viewing system according to claim 1, wherein when a new future task of alarm type appears, a specific icon is displayed.

11. Viewing system according to claim 1, wherein the man-machine interface comprises means making it possible to reveal for an icon representing a given task, either other icons representing associated tasks, or graphical windows, or menus.

12. Viewing system according to claim 2, wherein the time scale is horizontal and in that the viewing device also displays, under the line of the graphical icons, a vertical cross-sectional view of the terrain overflown in the course of the flight or mission.

13. Viewing system according to claim 2, wherein the time scale is horizontal and in that the viewing device also displays, under the line of the graphical icons, a vertical cross-sectional view of the flight plan.

14. Viewing system according to claim 1, wherein the icons have the form of different size circles.

15. Viewing system according to claim 1, wherein the icons have the form of polygons or a set the geometric shapes, circles and polygons.

16. Viewing system according to claim 1, wherein the time scale is centred on the present instant and is limited to a shorter duration than that of the complete process.

17. Viewing system according to claim 2, wherein the icons representing the tasks performed have a different representation from the icons representing the tasks yet to be performed.

18. Viewing system according to claim 2, wherein the icons representing the tasks not performed and which ought to have been, have a different representation from the icons representing tasks performed or to be performed.

19. Viewing system according to claim 2, wherein certain icons represent prohibited tasks.

20. Viewing system according to claim 2, wherein certain icons represent the tasks to be performed by a given operator.

21. Viewing system according to claim 2, wherein when a determined time interval comprises a large number of tasks, the man-machine interface comprises means making it possible either to carry out a “zoom” of this time interval, or an expansion, or a reorganization.

22. Viewing system according to claim 2, wherein a second symbol linking at least two icons is representative of the tempo at which the tasks represented by the said two icons are carried out.

23. Viewing system according to claim 2, wherein when a new future task of alarm type appears, a specific icon is displayed.

24. Viewing system according to claim 2, wherein the man-machine interface comprises means making it possible to reveal for an icon representing a given task, either other icons representing associated tasks, or graphical windows, or menus.

25. Viewing system according to claim 2, wherein the icons have the form of different size circles.

26. Viewing system according to claim 2, wherein the icons have the form of polygons or a set the geometric shapes, circles, and polygons.

27. Viewing system according to claim 2, wherein the time scale is centred on the present instant and is limited to a shorter duration that that of the complete process.
